(19) United States
(12) Patent Application Publication
(10) Pub. No.: US 2022/0078311 A1
(43) Pub. Date: Mar. 10, 2022

(54) IMAGE FORMING APPARATUS

(71) Applicant: KYOCERA Document Solutions Inc., Osaka-shi (JP)

(72) Inventor: Ayumi NAKANO, Osaka-shi (JP)

(21) Appl. No.: 17/467,499

(22) Filed: Sep. 7, 2021

(30) Foreign Application Priority Data
Sep. 7, 2020 (JP) 2020-149676

(51) Int. Cl. H04N 1/60

(52) U.S. Cl. CPC H04N 1/6033; H04N 1/6013

(57) ABSTRACT

An image forming apparatus is obtained in which a request level allowed by a user for image quality degradation is specified, and image adjustment process is executed according to the request level. The request level setting unit 32 (a) causes the printing apparatus 23 to print a test chart for inquiring a user about the request level of the image quality of the print product of the printing apparatus 23, (b) receives the user's response indicating the user's request level for the test chart, (c) specifies the user's request level, and sets the specified request level in the image adjustment process of the printing apparatus 23. The image adjustment processing unit 33 executes image adjustment process corresponding to the set request level.

### INCORPORATION BY REFERENCE

This application is based upon, and claims the benefit of priority from, corresponding Japanese Patent Application No. 2020-149676 filed in the Japan Patent Office on Sep. 7, 2020, the entire contents of which are incorporated herein by reference.

### BACKGROUND

This disclosure relates to image forming apparatus.

An image forming apparatus outputs an output chart including a plurality of color candidates and a check box for selecting a user desired color from the plurality of color candidates, reads the output chart in which the user has filled in a check box, and registers a color corresponding to the check box filled in by the user.

### SUMMARY

An image forming apparatus according to the present disclosure comprises: a printing apparatus; a request level setting unit which (a) causes the printing apparatus to print a test chart for inquiring a user about a request level of image quality of a print product of the printing apparatus; (b) receives a response from the user indicating the request level of the user with respect to the test chart; (c) specifies the request level of the user and sets the specified request level as an image adjustment process of the printing apparatus; and the image adjustment processing unit which executes the image adjustment process according to the set request level.

### BRIEF DESCRIPTION OF THE DRAWINGS

FIG. 1 is a block diagram showing a configuration of an image forming apparatus according to an embodiment of the present disclosure.

FIG. 2 is a view for explaining a test chart.

FIG. 3 is a flowchart for explaining the operation of the image forming apparatus 1 shown in FIG. 1

### DETAILED DESCRIPTION

Hereinafter, embodiments of the present disclosure will be described with reference to the drawings.

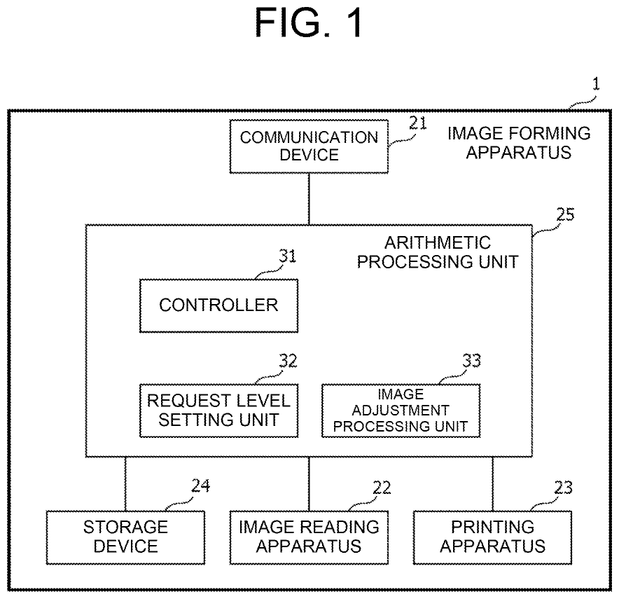

FIG. 1 is a block diagram showing a configuration of an image forming apparatus according to an embodiment of the present disclosure. The image forming apparatus 1 shown in FIG. 1 is a device having a printing function such as a printer or a multifunction machine, and includes a communication device 21, an image reading apparatus 22, a printing apparatus 23, a non-volatile storage device 24, and an arithmetic processing unit 25.

The communication device 21 performs data communication with a host device or the like. The image reading apparatus 22 optically reads a document image from a manuscript and generates image data for the document image. The printing apparatus 23 prints an image based on image data on a print sheet by, for example, an electrophotographic system.

The arithmetic processing unit 25 includes a computer which loads a program from a ASIC (Application Specific Integrated Circuit), a ROM (Read Only Memory), a storage device 24 or the like into a RAM (Random Access Memory) and executes the program in a CPU (Central Processing Unit), and operates as various processing units by the ASIC, the computer or the like.

In this embodiment, the arithmetic processing unit 25 functions as a controller 31, a request level setting unit 32, and an image adjustment processing unit 33.

The controller 31 executes a job (print job or the like) corresponding to a job request by the user by using an internal device such as an image reading apparatus 22 or a printing apparatus 23.

A request level setting unit 32 makes (a) a printing apparatus 23 print a test chart for inquiring a user about a request level of image quality of a print product of the printing apparatus 23, (b) receives the user's response indicating the user's request level to the test chart, (c) specifies the user's request level, and sets the specified request level to image adjustment process of the printing apparatus 23.

In this embodiment, the request level setting unit 32 causes the image reading apparatus 22 to read the image of the test chart in which the user's response is written, and specifies the user's response from the image of the test chart read by the image reading apparatus 22. Alternatively, the user may directly input the user's response to an operation panel (not shown) or the like, and the request level setting unit 32 may specify the input response.

The image adjustment processing unit 33 executes image adjustment process corresponding to the request level set by the request level setting unit 32.

The image adjustment processing unit 33 sets at least one of the type and frequency of image adjustment process in accordance with the request level. For example, when the user's request level is at a predetermined low level among a plurality of levels, the frequency of image adjustment process is reduced, and when the user's request level is at a predetermined high level among a plurality of levels, the frequency of image adjustment process is increased. For example, when the user's request level is at the predetermined low level among the plurality of levels, an automatic adjustment is selected by relatively few user operations among a plurality of image adjustment processes, and when the user's request level is at the predetermined high level among the plurality of levels, a manual adjustment is selected by relatively many user operations among the plurality of image adjustment processes to achieve high image quality.

For example, the automatic adjustment described above is calibration of the printing apparatus 23. In calibration, a patch image is toner developed, the density of the patch image is detected by a sensor in the printing apparatus 23, and adjustment of the toner density and the toner gradation, adjustment of registration, and the like, are automatically performed based on the detected density.

For example, in the above-described manual adjustment, a test chart for detecting density variation and positional deviation is printed, an image of the test chart is read by the image reading apparatus 22, or the like, based on a user operation, and adjustment of toner density and toner gradation, adjustment of registration, and the like, are performed based on the density and position of a patch image in the image of the test chart.

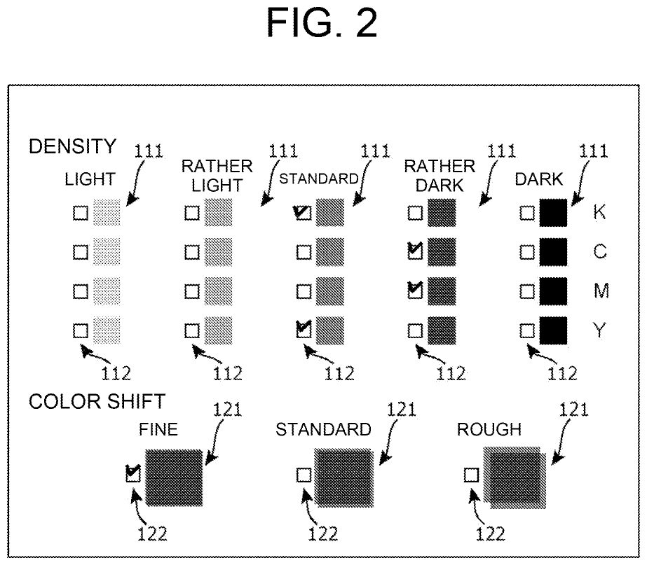

FIG. 2 is a view for explaining the test chart described above.

In this embodiment, the test chart includes a plurality of patches 111 showing density variations, for example, as shown in FIG. 2. The request level setting unit 32 specifies a request level of density variation, and the image adjustment processing unit 33 executes image adjustment process corresponding to the request level of density variation. The plurality of patches 111 are patch images having mutually different densities of the toner colors of the printing apparatus 23 (i.e. images formed of single toners such as cyan, magenta, yellow and black). The test chart also includes a check box 112 for the user to enter a request level for each toner color. In the test chart, the user responds with his or her request level by checking the check box 112 corresponding to the request level for each toner color.

Further, in this embodiment, as shown in FIG. 2, for example, the test chart includes a plurality of patches indicating color shifts with different amounts of shift, the request level setting unit 32 specifies a color shift request level, and the image adjustment processing unit 33 executes image adjustment process in accordance with the color shift request level. The patch for the color shift is obtained by overlapping two patches of a plurality of toner colors such as cyan, magenta, yellow, and black with mutually different shift amounts (shift amounts in one or both of the main scanning direction and the sub-scanning direction). The test chart also includes a check box 122 for the user to enter a request level for each toner color. In the test chart, the user responds with his or her request level by checking off the check box 122 corresponding to the request level for the color shift.

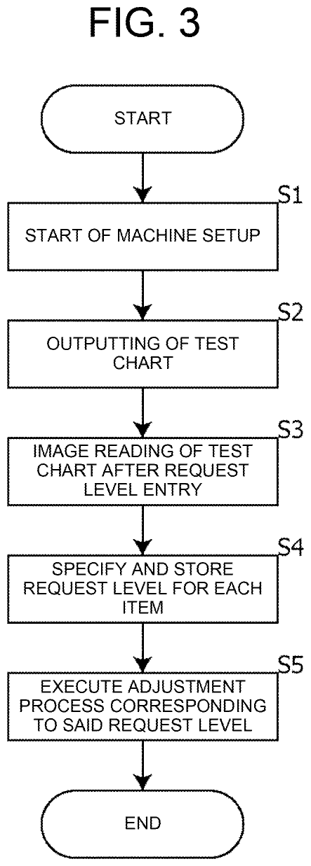

Next, the operation of the image forming apparatus 1 will be described. FIG. 3 is a flowchart for explaining the operation of the image forming apparatus 1 shown in FIG. 1.

When the user performs a predetermined operation on the image forming apparatus 1, machine setup of the “image forming apparatus 1” is started (step S1)

Then, the request level setting unit 32 prints the above-described test chart by the printing apparatus 23 in accordance with a user operation (step S2).

The user checks the printed test chart, responds with the user's request level, sets the test chart after the response to the image reading apparatus 22, and performs a predetermined operation on image forming apparatus 1.

In accordance with the operation, the request level setting unit 32 causes the image reading apparatus 22 to execute image reading of the test chart after the response and acquires an image of the test chart after the response (step S3).

The request level setting unit 32 specifies the user's response about the request level (that is, the request level designated by the user) based on the acquired image of the test chart after the response, and stores the request level in the storage device 24 in association with a user ID, a machine ID, or the like (step S4). For example, in the case of the test chart shown in FIG. 2, the positions of the check boxes 112 and 122 are specified by pattern matching or the like, the check boxes 112 and 122 checked by the user are specified, and the request level corresponding to the specified check boxes 112 and 122 is specified as the request level specified by the user.

Then, the image adjustment processing unit 33 refers to the request level stored in the storage device 24 to determine the methods and frequencies of image adjustment for maintaining image quality, and thereafter executes image adjustment process in the determined methods and frequencies (step S5). For example, in the test chart shown in FIG. 2, the method and frequency of density adjustment are individually determined for each toner color, and the method and frequency of position adjustment between toner colors are individually determined.

As described above, according to the above-described embodiment, the request level setting unit 32 (a) causes the printing apparatus 23 to print a test chart for inquiring the user about the request level of the image quality of the print product of the printing apparatus 23, (b) receives a user response indicating the user's request level for the test chart, (c) specifies the user's request level, and sets the specified request level in the image adjustment process of the printing apparatus 23. The image adjustment processing unit 33 executes image adjustment process corresponding to the set request level.

As a result, a request level allowed by the user for image quality degradation is specified, and image adjustment process corresponding to the request level is performed. Therefore, it is possible to prevent the user from feeling that the image quality is low due to the image adjustment process not being sufficiently performed and prevent lowering of the user's convenience due to the image adjustment process being excessively performed.

Various changes and modifications to the above-described embodiments will be apparent to those skilled in the art. Such changes and modifications may be made without departing from the spirit and scope of the subject matter and without diminishing the intended advantages. That is, such changes and modifications are intended to fall within the scope of the claims.

What is claimed is:

1. An image forming apparatus comprising: a printing apparatus;
a request level setting unit that: (a) causes the printing apparatus to print a test chart for inquiring a user about a request level of image quality of a print product of the printing apparatus;
(b) receives a response from the user indicating the request level of the user for the test chart;
and (c) specifies the request level of the user and sets the specified request level as an image adjustment process of the printing apparatus;
the image adjustment processing unit that executes the image adjustment process according to the set request level.

2. The image forming apparatus according to claim 1,
wherein the test chart includes a plurality of patches indicating density variation; the request level setting unit specifies a request level of the density variation,
and the image adjustment processing unit executes the image adjustment process according to the request level of the density variation.

3. The image forming apparatus according to claim 1,
wherein the plurality of patches are patch images having mutually different densities of toner colors of the printing apparatus.

4. The image forming apparatus according to claim 1,
wherein the test chart includes a plurality of patches indicating color shifts having different shift amounts,
the request level setting unit specifies a request level of the color shift,
and the image adjustment processing unit executes the image adjustment process according to the request level of the color shift.

5. The image forming apparatus according to claim 1,
wherein the image adjustment processing unit sets at least one of a type and a frequency of the image adjustment process according to the request level.

6. The image forming apparatus according to claim 1, further comprising an image reading apparatus,
wherein the request level setting unit causes the image reading apparatus to read an image of the test chart on which a response of the user is written,
and specifies the response of the user from the image of the test chart read by the image reading apparatus.
